(19) United States
(12) Patent Application Publication
(10) Pub. No.: US 2022/0405819 A1
(43) Pub. Date: Dec. 22, 2022

(54) SYSTEM AND METHOD FOR INTEGRATING COMMUNICATION CHANNELS

(71) Applicant: Centro, LLC, Boulder, CO (US)

(72) Inventors: Bailey Lin Carlson, Denver, CO (US); Ryan Arthur Hitchler, Superior, CO (US); Timothy Paul Schultz, Chicago, IL (US)

(73) Assignee: Centro, LLC, Boulder, CO (US)

(21) Appl. No.: 17/845,710

(22) Filed: Jun. 21, 2022

Related U.S. Application Data
(60) Provisional application No. 63/212,443, filed on Jun. 18, 2021.

(51) Int. Cl. G06Q 30/06; G06F 40/40; G06F 40/166

(52) U.S. Cl. CPC G06Q 30/0613; G06F 40/40; G06F 40/166

(57) ABSTRACT

A systems and method for integrating communications channels and threads with a Customer Relations Management (CRM) platform, such as Salesforce. The system includes methods for linking communication channels with specific records and generating reports such as summaries and digests for select communication threads.

### CROSS REFERENCE TO RELATED APPLICATION

The present application claims the benefit of, pursuant to 35 U.S.C. § 119(e), U.S. provisional patent application Ser. No. 63/212,443 filed Jun. 18, 2021, the entirety of which is incorporated by reference herein.

### FIELD OF INVENTION

The present application relates to systems and methods for integrating various communication channels, forms and/or forums with another platform, for example, a customer relations management platform such as Salesforce.

### COPYRIGHT NOTICE

A portion of this disclosure is subject to copyright protection. Limited permission is granted to facsimile reproduction of the patent document or patent disclosure as it appears in the U.S. Patent and Trademark Office (USPTO) patent file or records. The copyright owner reserves all other copyright rights whatsoever.

### BACKGROUND OF THE INVENTION

Business and finance-related systems contain information in a variety of different manners, and increasingly contain a quantity of data that makes it difficult, if not impossible, for an individual (or multiple individuals) to quickly retrieve and analyze. Such information may be derived from a source document or from several sources of data, updated on a daily, weekly or monthly basis, and in some instances may be updated constantly or involve streaming data. This information may be organized according to one or more formats or systems, further complicating the retrieval and analysis of such information.

Communications between individual users, including those in the same or different organizations, is kept in an even greater variety of formats. The Internet allows various communication forms, but conversations occurring via those forms are often busy, unorganized and at times chaotic. Most communication systems are not easily integrated or searchable, creating loss of information or difficulty capturing the specific information communicated from one user to another, or among larger groups of users.

With the advent of networking, companies and organizations have depended on software-based communications and research tools to manage enterprise activities and to attempt to improve workforce performance, streamline workflow, improve service, decrease downtime and the like. Modern network-supported communication channels include email applications, instant messaging applications, file sharing applications, network collaboration software, time management applications, central directory applications, network telephony and mobile video-conferencing applications, among several of others. More recently, new communication channels, such as Slack, have developed and are routinely used among enterprise users. Some of these applications are often packaged together as Customer Relations Management (CRM), Internal Relations Management (IRM), and Business-to-Business (B2B) Enterprise Solutions, although many are not. As a result of the emergence of these and other applications across enterprise platforms, several issues have arisen and remain unresolved.

One enterprise communication issue is inadvertent discovery, which can lead to loss of privacy. Even if, for example, a Virtual Private Network security protocol is successful is protecting the data within a given communication, potentially unwanted observers can still determine a significant amount of information about the given communication. For example, a potentially unwanted observer may observe the communication protocol used for the communication to gain another level of insight into a communication between two individual users. In certain applications, the level of security protocols needed to protect communications from loss of privacy impedes the efficient use of the communication platform. This problem is particular inherent in today's enterprise communication platforms.

In addition, enterprise workers often must generate workflows and/or spend inordinate amounts of time trying to locate relevant information within the enterprise that may be critical to their tasks, or that must be communicated quickly and efficiently to other workers. In many cases, the user must order data from an authorized individual gatekeeper or system resource, and often must wait until the requestee can accommodate and approve the request. In these scenarios, there often is no smooth, incoming flow of task relevant data to the worker. If the worker has an internal search tool (in many instances they do not) often much irrelevant data is included in a search result with a small portion of relevant information that the worker must sift through manually, creating further inefficiencies.

While numerous prior solutions have attempted to improve upon enterprise communications, device, and data security, deficiencies still persist. It is with respect to these deficiencies and other shortcomings in the prior art that the present invention is directed.

### SUMMARY OF INVENTION

Embodiments of the present disclosure relate to integration between two or more platforms, for example, Salesforce and Slack, which permit individuals or groups of individuals using the two or more platforms to work efficiently. The present invention includes systems and methods that employ a natural language processing (“NLP”) tool to generate summaries and create tasks from a selected conversation(s) and permit users to access and manipulate the selected conversation(s) in Salesforce, for example.

In embodiments, the communication channel, form or forum is Slack. In yet other embodiments, a different or additional communication channel is selected.

In further embodiments, by way of example but not limitation, the NLP tool may consist of (but not necessarily limited to) “GPT-3” from OpenAI. In other embodiments, additional or alternative NLP tools and processes may be employed without departing from the novel aspects of the present invention.

In embodiments, the present disclosure relates to tools capable of being configured to link and organize Slack channels in Salesforce or another Customer Relations Management (“CRM”) platform. In one embodiment, a user may link one or more communication channels or threads from a particular communication channel in, by way of example, Salesforce. In one aspect, the linked channels or threads may be coupled to a particular record. In one embodiment, the channel linking may occur with respect to a specific communication platform channel, such as a Slack channel, and be linked to a specific Salesforce record.

In another aspect, a user my utilize the NLP tools described in detail below for creating, autonomously, a communication channel or thread “summary” that includes an overview of a conversation occurring between two or more users. A user may also create a daily digest of subscribed channels, for example, using the NLP tools described herein.

In another aspect, the system and method described below may be utilized to search for specific records or communication channels based upon the linked data, such as the conversations occurring on a linked Slack channel. A user may alternatively search for an existing communication channel in order to identify one or more channels to link to a specific record.

In yet another aspect, a user may configure related objects in Salesforce, for example, to further link a communication channel to the associated record. For example, objects like Contact, Opportunity or Case may be selected for creating a more specific link between the communication channel and the CRM platform.

In another aspect, a user may create records through the communication channel, such as in Slack. A user may perform this task either by creating a new record or by associating related records or posted messages with a record. Furthermore, posted messages may be edited for a particular record, including through Slack or another communication channel.

In another aspect, the system and method may be utilized to change or assign ownership of a particular record, including through Slack. A user may assign, for example, a new lead or other ownership criteria for another user to accept.

The system and method further comprises creation of workflow templates, such as email or other communication templates. The system may also be utilized to update Salesforce with a custom form, which comprises steps to create or edit a Salesforce record.

A user may also post a Salesforce record as a Slack message, for example, using the system and method described below.

Certain terms are used throughout the following description and claims to refer to particular system components. As one skilled in the art will appreciate, companies may refer to a component by different names. This document does not intend to distinguish between components that differ in name but not function.

As used herein, the term “couple” or “couples” is intended to mean either an indirect or direct connection. When used in a mechanical context, if a first component couples or is coupled to a second component, the connection between the components may be through a direct engagement of the two components, or through an indirect connection that is accomplished via other intermediate components, devices and/or connections. In addition, when used in an electrical context, if a first device couples to a second device, that connection may be through a direct electrical connection, or through an indirect electrical connection via other devices and connections. Connections can occur in a unidirectional, bidirectional or variable directional manner over all known means of network connectivity.

As used herein, the term “user” refers to a uniquely identifiable construct within a system that is able to perform an action within the system. This action is not limited in scope and can include such things as create, read, update, delete (CRUD) options, transport, transformation, communications and so forth. For example, a “user” is not limited to a human being, but also includes processes, services, and other such subsystems and code that can be assigned unique identifiers. Thus, a user differs from a unique option such as a row identifier in a database table, which is unable to take any action on the system. In some instances, a user refers to a logical construct such as a user of a virtual machine running within the context of a physical device. In this instance, the virtual user is a version of the user mapping of the application hosting the virtual machine.

As used herein, the general term “device” refers to either a physical device (or group of physical devices) or a virtual machine or device. A physical device generally refers to the physical and software resources required to run an operating system and supporting software. A virtual machine generally refers to an emulation of a computer system, which may be carried out by a physical device or a collection of physical devices acting towards one logical purpose. Grid computing and clustered servers are examples of multiple devices working towards one logical purpose.

As used herein, the terms “user device” and “active user device” refer to the logical intersection of a device and a user. Users and devices may have a many-to-many relationship and thus multiple user devices may exist within a given device or for a given user at any one time.

As used herein, the term “platform” refers to a grouping of similar devices. Devices may be grouped based on the type of operating system used, the type of device itself (e.g., secured/unsecured, desktop/laptop/mobile, client/server) or another distinction that identifies devices in a given system either by its presence and variability among devices or by it lack of presence in some subset of devices. Thus, as used herein, the term “cross-platform” as in “cross-platform communication” refers to devices of two different platforms that communicate with one another.

As used herein, the term “operation” or “performing an operation” refers to an operation such as encrypting a communication packet, replacing the packet with an alternate packet, deleting the packet, cloning the packet, replacing the packet with a packet pointer, and the like. Performing an operation on a packet may be restricted to only a portion of the communication packet.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and claims are to be understood as being approximations which may be modified in all instances as required for a particular application of the novel apparatus described herein.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein. In the following disclosure and in the claims, the terms “including” and “comprising” are used in an open-ended fashion, and thus should be interpreted to mean “including, but not limited to. . . . ”

By way of providing additional background, context, and to further satisfy the written description requirements of 35 U.S.C. § 112, the following are incorporated by reference in their entireties for the express purpose of explaining and further describing aspects of the platforms and communication channels described herein: U.S. Pat. No. 10,229,204 entitled “Messaging Search and Management Apparatuses, Methods and Systems” issued on Mar. 12, 2019.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description, Abstract, and Claims themselves.

This Summary is neither intended, nor should it be construed, as being representative of the full extent and scope of the present disclosure. Moreover, references made herein to “the present disclosure” or aspects thereof should be understood to mean certain embodiments of the present disclosure and should not necessarily be construed as limiting all embodiments to a particular description. The present disclosure is set forth in various levels of detail in the Summary as well as in the attached drawings and the Detailed Description, and no limitation as to the scope of the present disclosure is intended by either the inclusion or non-inclusion of elements or components when describing certain embodiments herein. Additional aspects of the present disclosure will become more readily apparent from the Detailed Description, particularly when taken together with the drawings.

The above-described benefits, embodiments, and/or characterizations are not necessarily complete or exhaustive, and in particular, as to the patentable subject matter disclosed herein. Other benefits, embodiments, and/or characterizations of the present disclosure are possible utilizing, alone or in combination, as set forth above and/or described in the accompanying figures and/or in the description herein below.

### BRIEF DESCRIPTION OF THE DRAWINGS

The accompanying drawings, which are incorporated herein and constitute a part of the specification, illustrate embodiments of the disclosure, and together with the Summary and the Detailed Description serve to explain the principles of these embodiments. In certain instances, details that are not necessary for an understanding of the disclosure or that render other details difficult to perceive may have been omitted. It should be understood, of course, that the present disclosure is not necessarily limited to the particular embodiments illustrated herein. Additionally, it should be understood that the drawings are not meant to be and/or are not necessarily to scale. In the drawings:

FIG. 1 depicts an embodiment for selecting and displaying linked communication channels for a particular Customer Relations Management (CRM) platform;

FIGS. 2A-2C depict an embodiment wherein a user links a specific channel with a specific CRM record and associates conversations via the specific channel with the specific record;

FIGS. 3A-3E depict embodiments for searching linked communication channels and/or specific records;

FIGS. 4A-4G depict embodiments for creating new records through the communication channel(s);

FIGS. 5A-5B depict an embodiment for editing records through a linked communication channel;

FIG. 6 depicts an embodiment for changing a CRM record owner through a linked communication channel;

FIGS. 7A-7F depict embodiments for generating a communication thread and templates associated with the same through a linked communication channel;

FIGS. 8A-8E depict embodiments for autonomously generating a conversation thread or channel summary and displaying the same;

FIGS. 9A-9C depict embodiments for creating a CRM record data utilizing a custom form;

FIG. 10 depicts an embodiment for posting a CRM record as a communication channel message;

FIG. 11 depicts an embodiment for triggering a CRM event or event-driven message inside and outside a CRM platform;

FIG. 12 depicts a flowchart illustrating certain steps of the embodiment depicted in FIG. 11;

FIGS. 13A-13F depict embodiments for creating and subscribing to communication channel summary and daily digest for a linked communication channel(s);

FIG. 14 depicts an embodiment for providing real-time or near real-time messaging from a linked communication channel within a CRM platform environment;

FIG. 15 depicts an embodiment for linking a thread or message between a CRM platform to a communication channel;

FIG. 16 depicts an embodiment for displaying a listing of records with sorting, filtering and searching capabilities;

FIG. 17 depicts an embodiment for a user to select a record for an action;

FIG. 18 depicts the embodiment of FIG. 17 for confirming batch actions;

FIG. 19 depicts an embodiment for establishing a list using a custom workflow;

FIG. 20 depicts an embodiment for displaying linked conversations and messaging queue; and

FIG. 21 depicts an interface for live messaging via one or more external web site(s).

### DETAILED DESCRIPTION

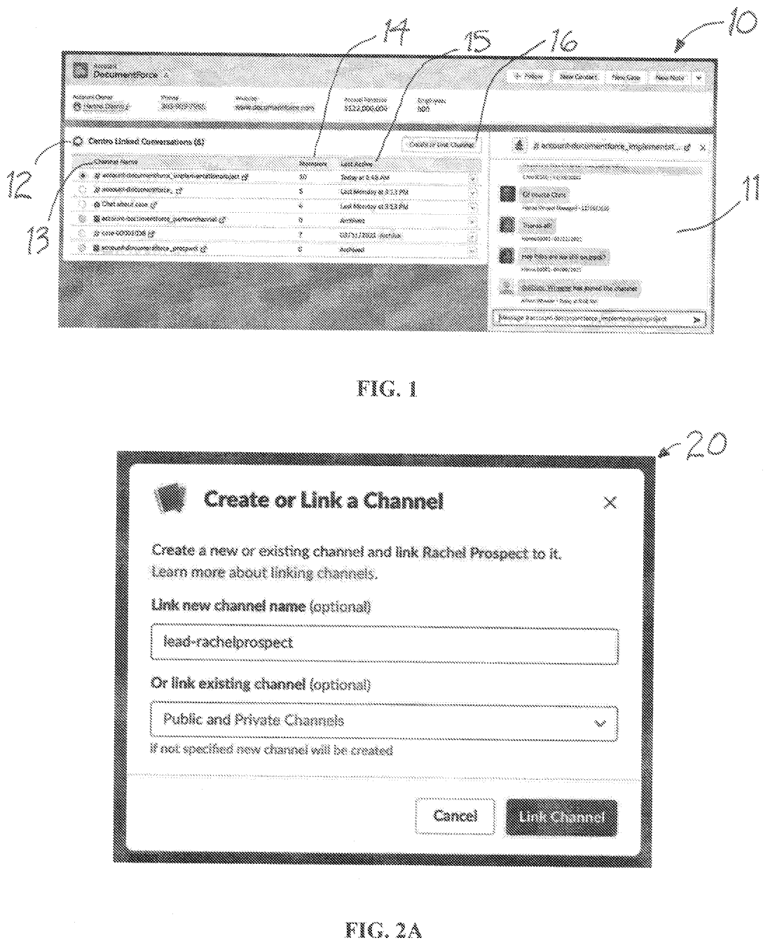

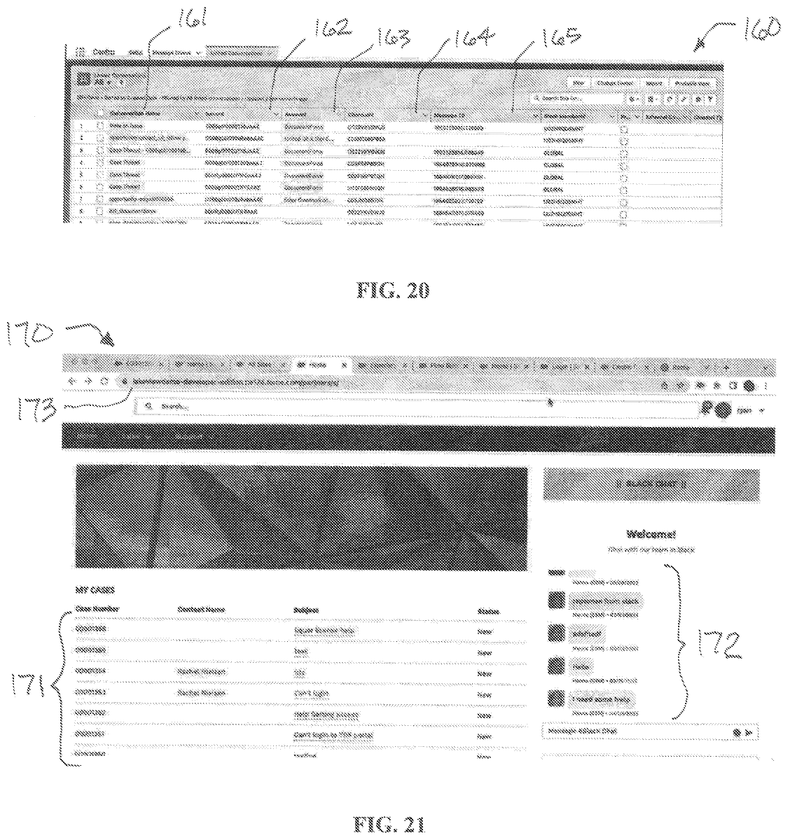

Embodiments of the present disclosure relate to integration between two or more platforms; by way of example but not limitation, embodiments may integrate communications between a Salesforce or other Customer Relations Management (CRM) platform and Slack or another user communication channel. Certain embodiments are illustrated in FIGS. 1-21 appended hereto. It is to be expressly understood that the embodiments illustrated in the Figures are for the purpose of streamlining this disclosure and are not exhaustive of the novel aspects of the system and method described herein, which are reflected in the claims. Thus, the Figures are intended to be exemplary of the manner of practicing the invention(s) claimed herein.

Referring now to FIG. 1, the system preferably comprises workflows for selecting and displaying linked communication channels for a particular Customer Relations Management (CRM) platform, such as Salesforce. For instance, the system 10 may comprise a messaging or chat feature 11 and a linked conversations feature 12. The linked conversations feature 12 may be organized in a variety of different manners, and may comprise details such as the channel name 13, membership 14, last modified or last activity 15, among other details. The user may have the option to Create or Link Channel(s) 16. These features preferably further comprise the ability to create new conversation threads within the system 10, as shown in FIG. 1.

The system provides dynamic linking and pinning of dialog created among authenticated users of, by way of example but not limitation, a CRM such as Salesforce and a communication forum such as Slack. The system includes tools and other utilities for streamlining activity among users across both CRM and communication forum workspaces. In an embodiment, once a user's credentials are established, the system configures and manages requests from either platform.

The system preferably comprises a database that comprises a Channel ID, which is coupled to the Salesforce Record ID (associated with the Slack workspace and Salesforce org respectively). One novel aspect of the system with respect to integrating Salesforce and Slack is referred to herein as “channel linking.” Channel linking associates a particular Salesforce record with a Slack channel. In a preferred embodiment, the system creates a new Channel for a particular Salesforce record. In alternate embodiments, the system permits a user to associate a Salesforce or other CRM record with an existing Slack channel. In yet other embodiments, a user may create a new Channel for use with an existing or new Salesforce record. Aspects of the system showing the linking of channels and records are depicted in FIG. 1.

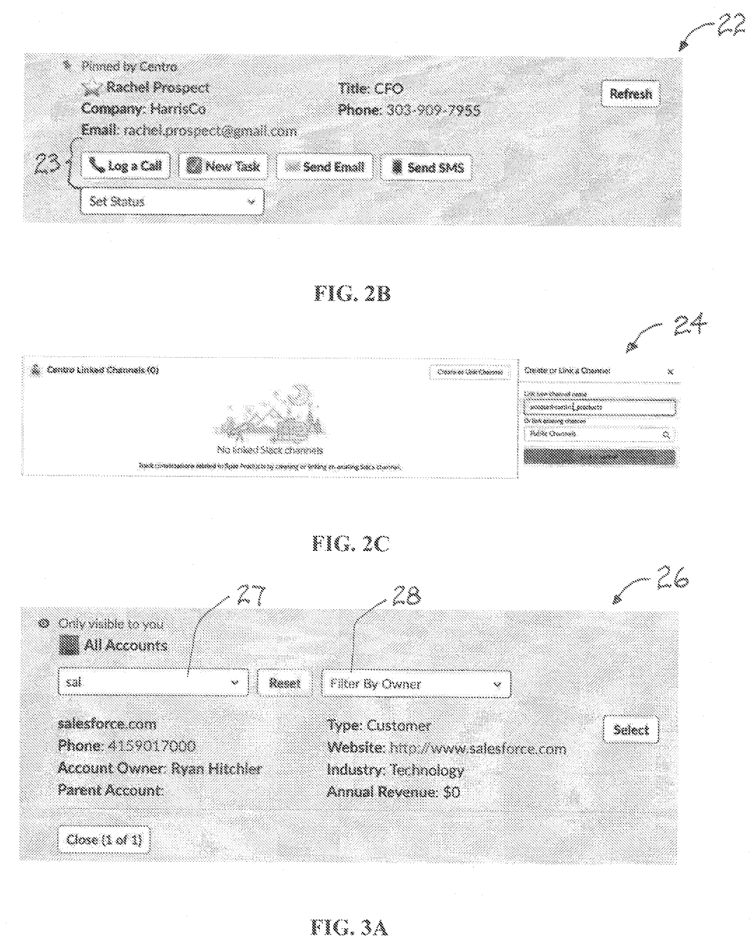

FIGS. 2A-2C further illustrate how a user creates or links a specific channel with a specific CRM record, as well as associated conversations via the specific channel with the specific record. Referring to FIG. 2A, the user may be presented with a dialog box 20 when the user initiates a query, such as a search for a particular record, or elects to create a new channel 16. Once a user links the record, it will post a message to the specified channel 22, as shown in FIG. 2B.

It is expressly noted that different Salesforce records may comprise different actions than depicted in FIGS. 2A-2B.

The system 10 preferably comprises an engine or bot that automatically pins a message to the channel. The action of creating a record link also occurs when invoked from the Salesforce component 24, as depicted in FIG. 2C. When creating or linking from Salesforce, the same behavior applies, and a new message will appear in the channel with the record from which it originated.

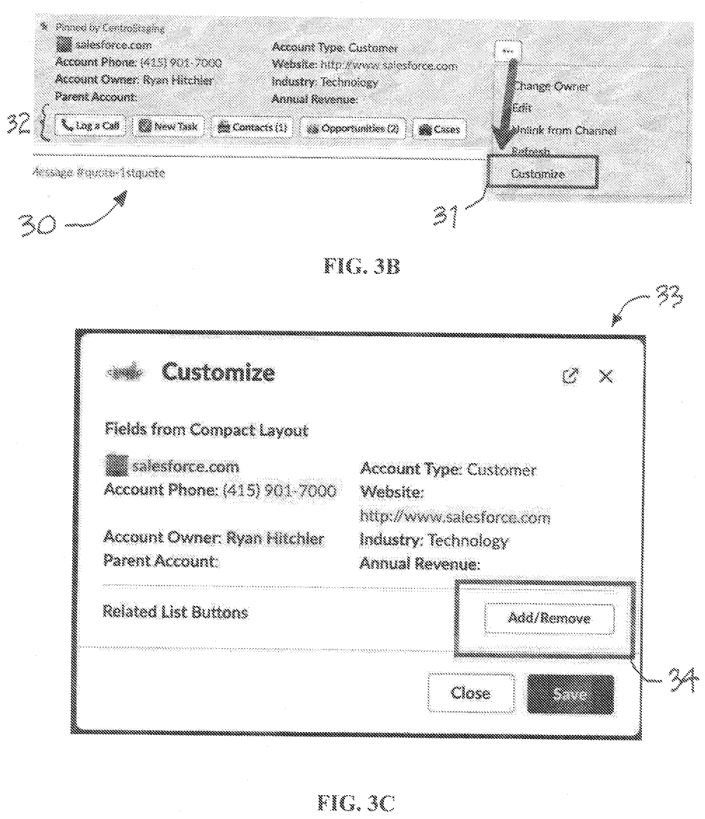

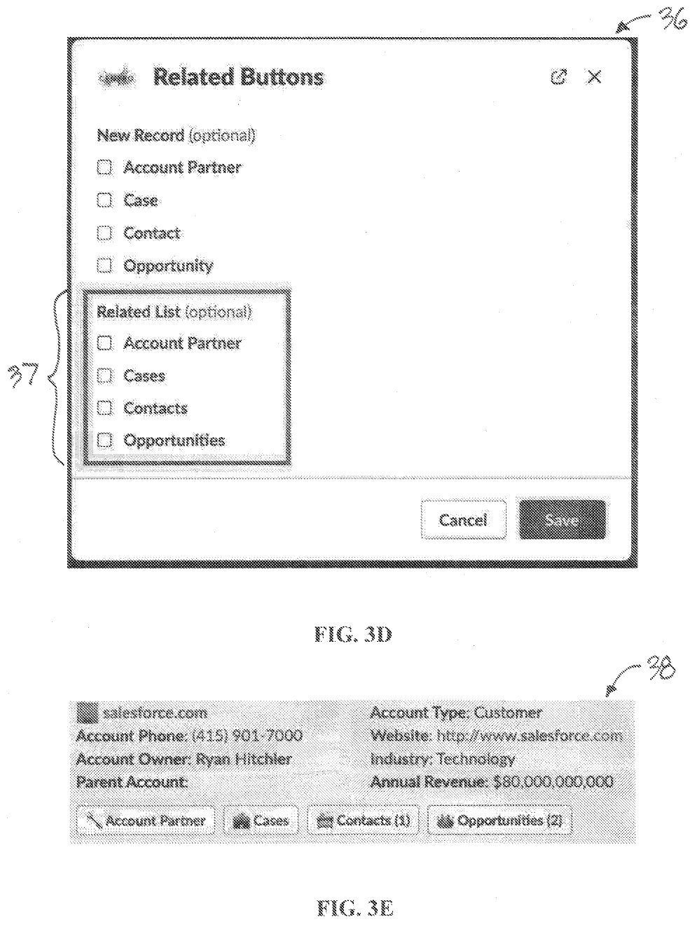

FIGS. 3A-3E depict embodiments for searching linked communication channels and/or specific records. A user may search for specific records using, for example, keyword search terms 27 and filters 28 provided by the system 10. In a preferred embodiment, the system provides at least two ways for searching for records in Slack: searching by object; and, by related records from a pinned or posted message block. Most commonly, searching for a record results in posting the record details for the channel to see in order to have context for the conversation, although in other embodiments no posting occurs from searching for a record.

A user also has the ability to engage in generic searching, which in one embodiment may be achieved by generating a search string for a specific record locator. For example, a user may input the string Use the “/centro<object API_name><search term>”. The method of initiating this particular search method is illustrated in FIG. 3A. From here, the user may Select a specific record locator to pin it to a new or existing channel 30, as shown in FIG. 3B. The user may be presented with a menu to select options such as Change Owner, Edit, Unlink from Channel, Refresh or Customize 31. A suer may also have shortcut icons 32 that initiate other actions.

Alternatively, a user may search by Related Records. From an established linked and posted message, the user may configure one or more related object buttons/icons. For example, if an account record is linked, a user may configure the related objects to the Account like Contact, Opportunity, Case or other objects. The user may be presented with a pick list or menu of options, such as the overflow menu for posted messages shown in FIG. 3B. Next, a user may select the “Add/Remove” button/icon 34 from the Related List section, as shown in FIG. 3C. Next, a user may select the related objects 36 the user would like to add or remove, as shown in FIG. 3D, which may comprise Account Partner, Cases, Contacts or Opportunities 37. The selected options appear on the posted message 38, preferably as arranged in FIG. 3E.

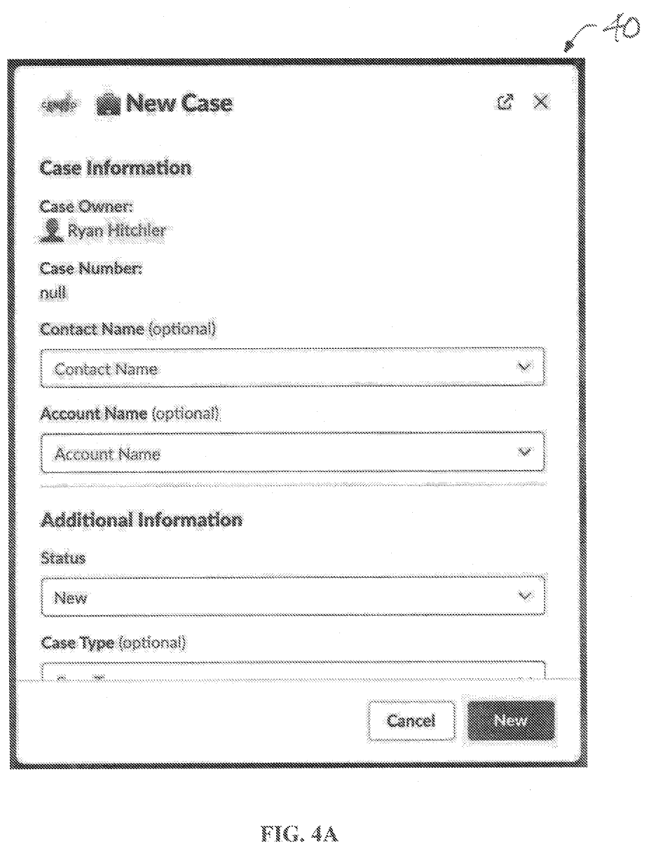

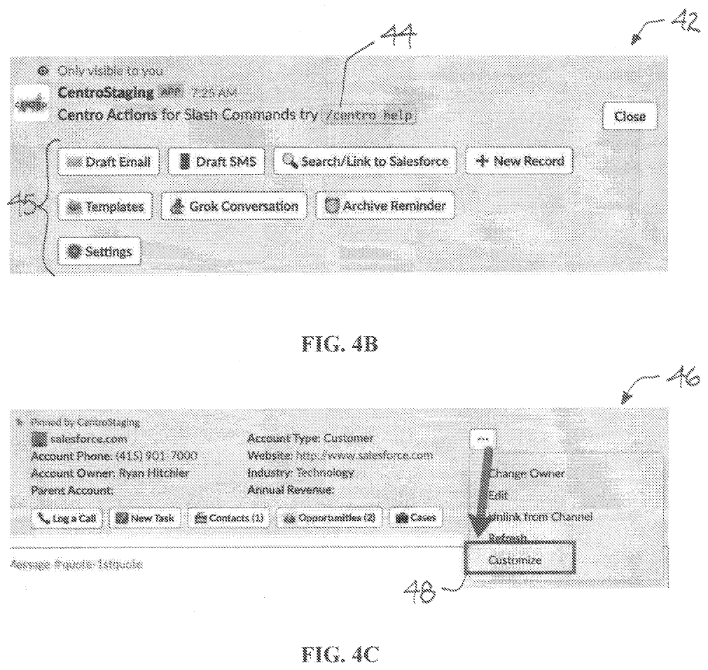

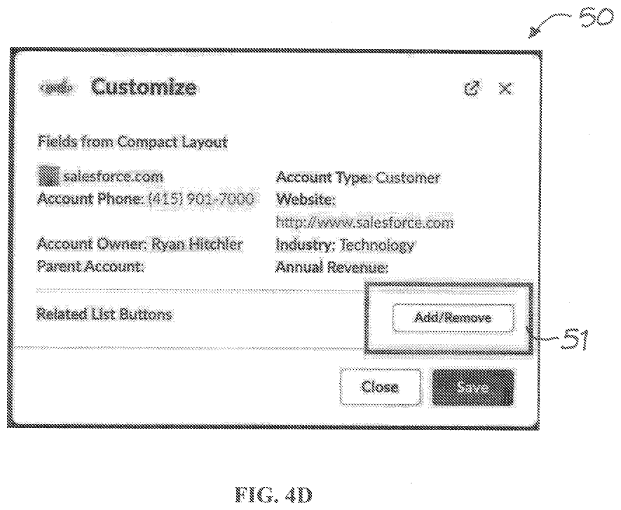

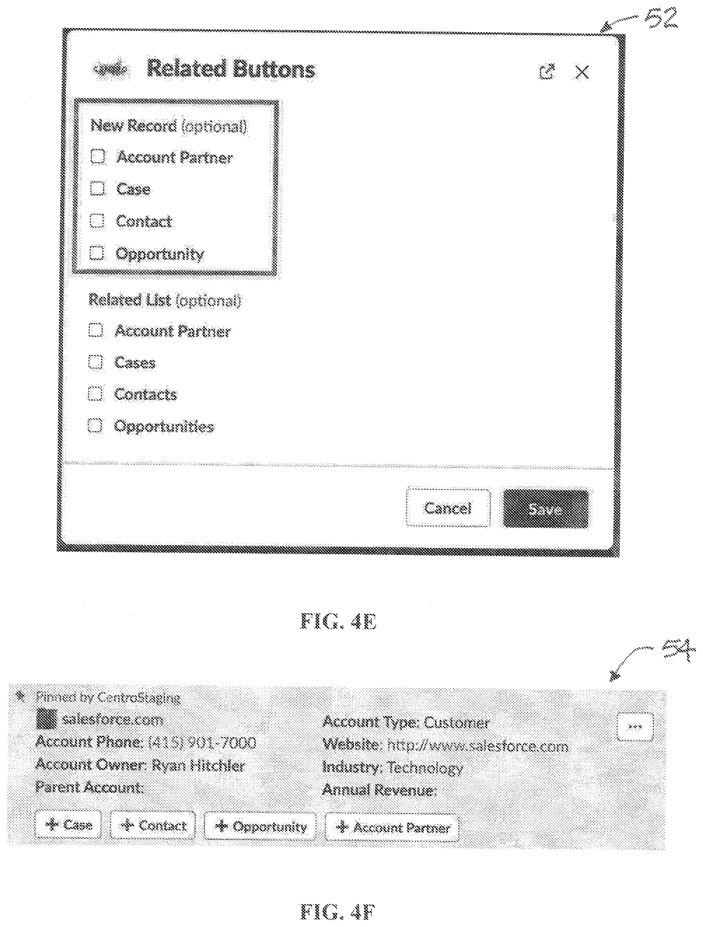

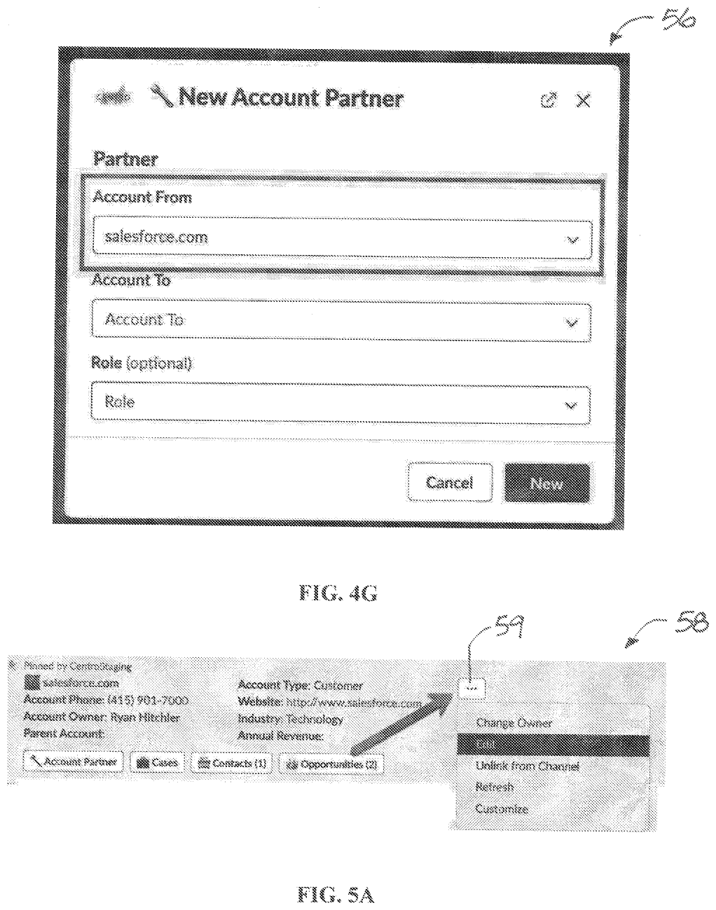

FIGS. 4A-4G show one method to create new records 40 through the communication channel(s). The system preferably provides at least two ways for creating new records in Slack: any object (at any time); and, by related records from a pinned or posted message block. The modal dialog for selecting fields is preferably taken from the Page Layout for the object in question.

A user may create a new record 40 using a generic creation method, such as by using the command “/centro new <object API_name>” as shown in FIG. 4A. Selecting the “/centro” command will also call up a set of quick action buttons 45, including a “new” record. This button/icon 44 will display new records for the standard objects and may be non-configurable, and is illustrated in the display 42 of FIG. 4B.

A user may also create by Related Records. From an established, linked and posted message, a user may configure related object buttons. For example, if an Account record is linked, a user may configure related objects to the Account, such as Contact, Opportunity, Case and the like. To do so, a user may open the overflow menu 48 for the posted message 46 as shown in

FIG. 4C. Then, the user may select the “Add/Remove” button 51 from the Related List section as shown in the pop up window 50 of FIG. 4D. The user may utilize this display 52 to select the related objects they wish to add or remove for creating new records, as shown in FIG. 4E.

The posted message block 54 will now show any new buttons/icons that were configured, as depicted in FIG. 4F. In a preferred embodiment, when creating records the lookup field is set automatically based on the message block record. In this manner, an administrative user may set up “Salesforce.com” as the default account lookup when a user selects the “Account Partner” icon 56, as shown in FIG. 4G.

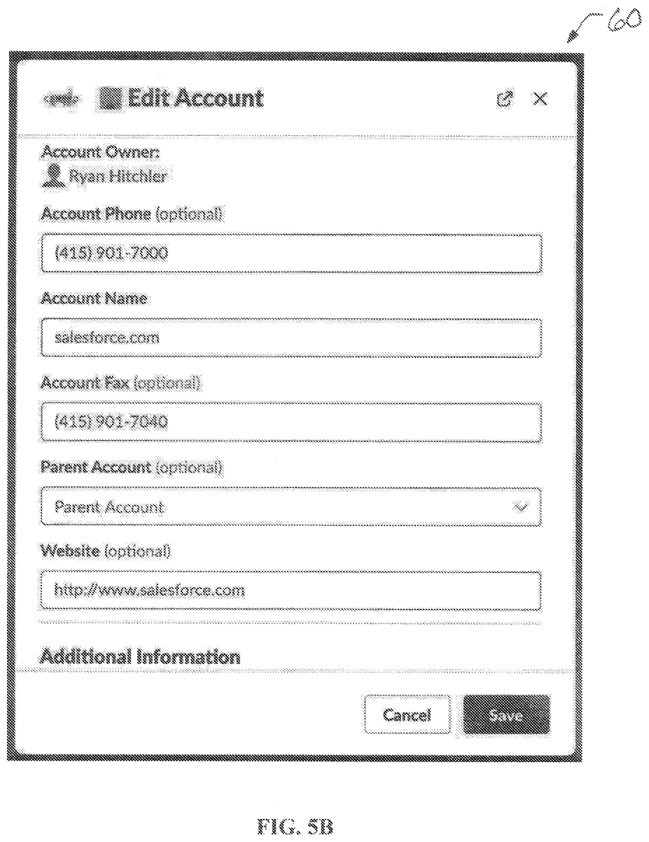

FIGS. 5A-5B illustrate how a user may edit records through a linked communication channel. A posted message with a Salesforce record may be edited, for example, using a similar dialog as the New Record method described above. However, unlike the New Record method, any existing data from the linked channel is populated in the record for users to update. From any posted message, a user may be presented with a menu 59 as shown in the display 58 of FIG. 5A. A modal dialog box 60 preferably displays the fields and sections of the page layout for the selected object. The data will preferably be populated in this dialog box as well, and a user may be presented with the display shown in FIG. 5B to continue editing the record. Once edits are saved by the user, the posted message will be updated in the Salesforce record.

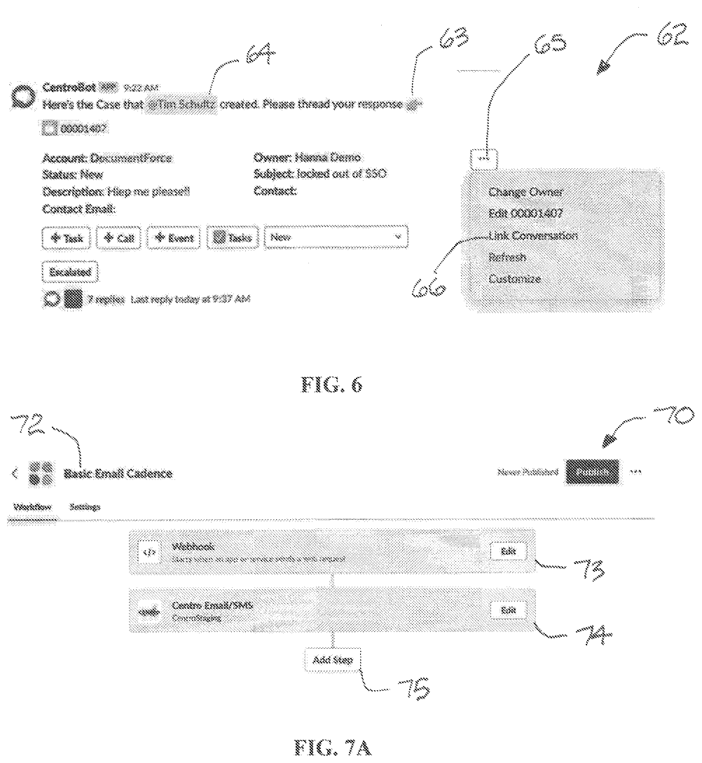

When using the push Leads or Case functions (from Salesforce), a user 64 may create new Slack messages or thread a response 63 in a designated channel any time a new Lead or Case is created in Salesforce, as depicted in the display 62 of FIG. 6. For teams of users processing the Leads or Cases, it may be beneficial to change the Owner, or to indicate to other users when this has transpired. The system enables this change through the overflow menu 65, which is illustrated in FIG. 6.

FIG. 6 further illustrates how to change a CRM record owner through a linked conversation 66 channel. Note that the Record details screen does not automatically update, and the user may be prompted to “Refresh” prior to updating. In other embodiments, the update occurs automatically without any prompt. In addition, Centro allows the user to Post to the channel that this change has occurred. This capability (as depicted and described in relation to FIG. 6) is available on all linked Salesforce Records that have Owners that are capable of being changed.

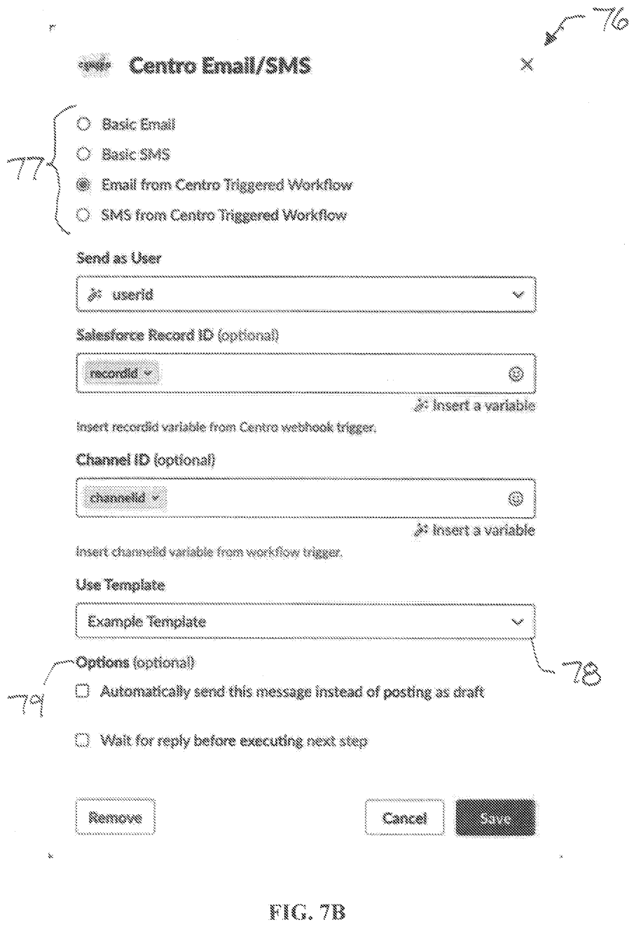

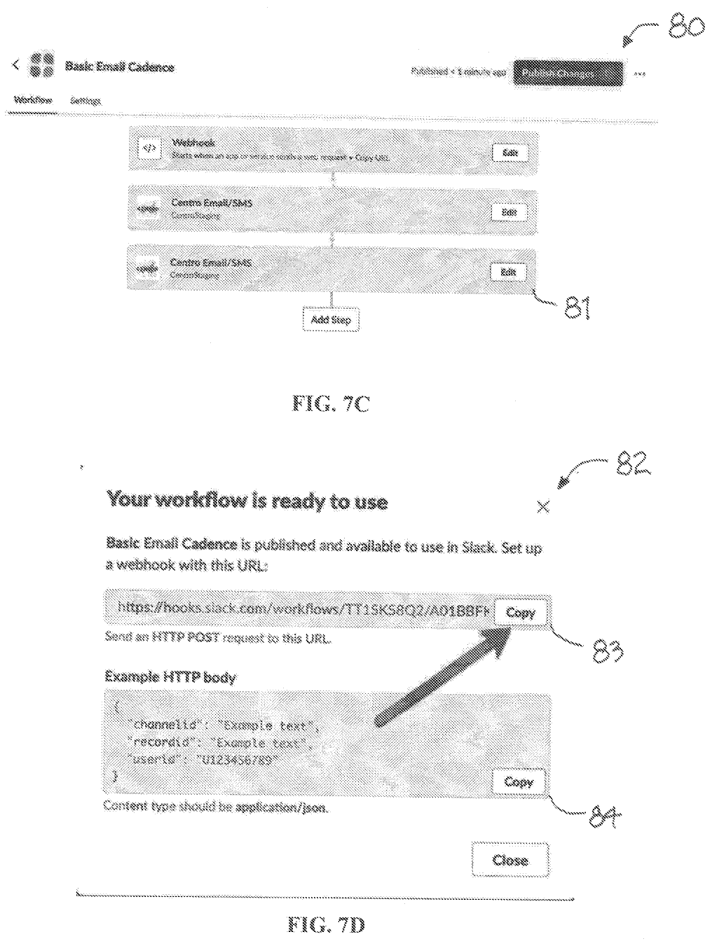

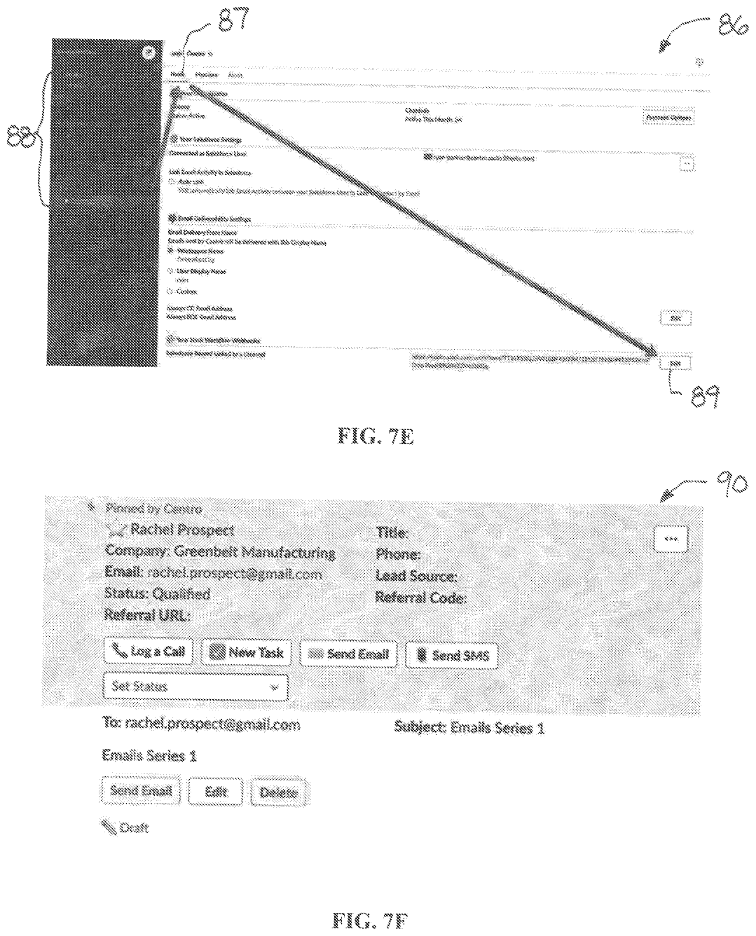

FIGS. 7A-7F show how a user may generate a communication thread and templates associated with the same through a linked communication channel 70. In this embodiment, several discrete steps may be performed, including creating one or more cadence email 72 templates for use in the system. For example, once a webhook 73 is established, the first email in the sequence 74 may be an introductory email after a web site visit. A second email may be added 75 if the prospect doesn't respond in a certain time frame (i.e., three days). Next, a user may download the example. Next, the user will navigate to Workflow Builder and select “Import.”

The user may select Edit in the Email/SMS step 76 as shown in FIG. 7B. Other fields, such as Send as User, Salesforce Record ID, and Channel ID preferably remain unedited. Under the menu option, a picklist item called Use Template 78 may be selected to choose the specific email template created above. A user may choose from several options 79, including to automatically send a template instead of drafting an email. A user may also specify a time period before sending a follow-on email (i.e., set the number of days before sending the next email in the sequence). Each of these sub-steps are depicted in FIG. 7B.

The user may add as many sub-steps in the sequence as desired. A user may select email and SMS (or both) 81, as shown in FIG. 7C. The user may then publish the custom workflow 80 so that another user may choose the template at a later time.

In embodiments, a user may link any template to the system, such as by selecting the Copy icon 83, thereby copying the webhook, as shown in the display 82 of FIG. 7D. The user also has the option to copy 84 the body of the HTTP text as well. The user may then paste the template into the system's database 86, as shown in FIG. 7E. The user may return and select to edit 89 the webhooks copied and pasted into Saleforce, or navigate through the system menu 88 to choose a different channel or thread.

Custom workflows may be configured to start when a Lead or a Contact is pinned to a Slack channel. In the above example, the first email in the sequence was drafted the moment a Lead was pinned, as depicted in the display 90 of FIG. 7F. In other examples, the user may specify to begin a workflow upon the occurrence of a different or subsequent event.

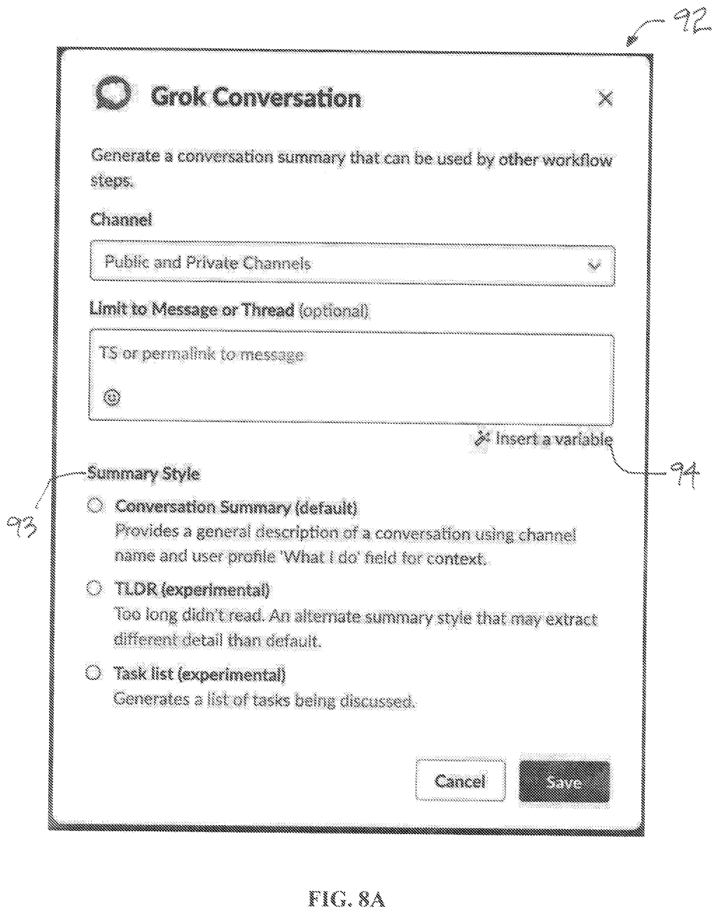

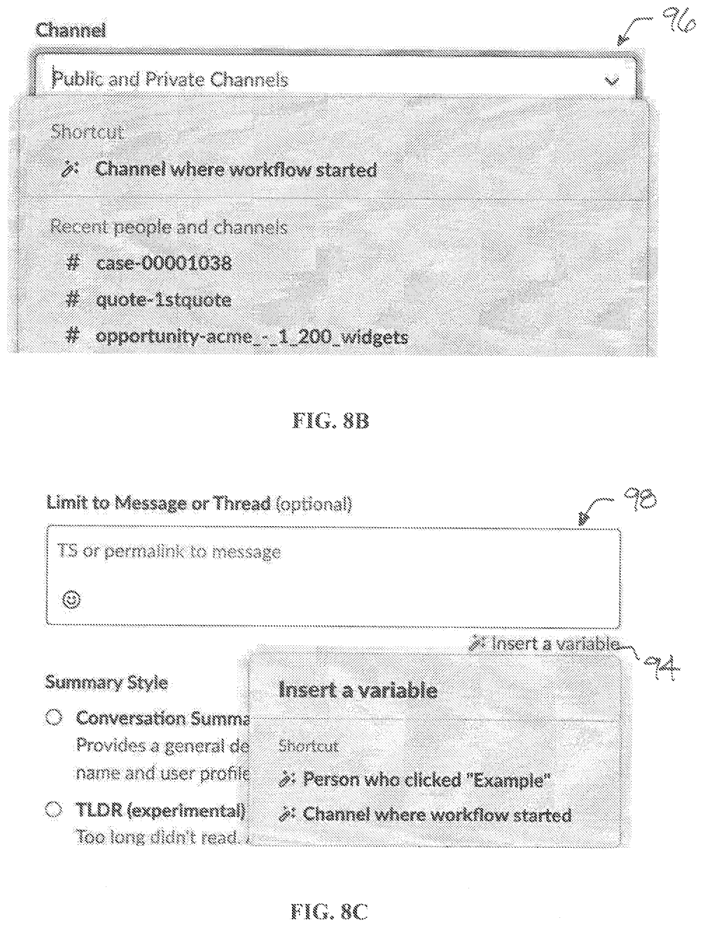

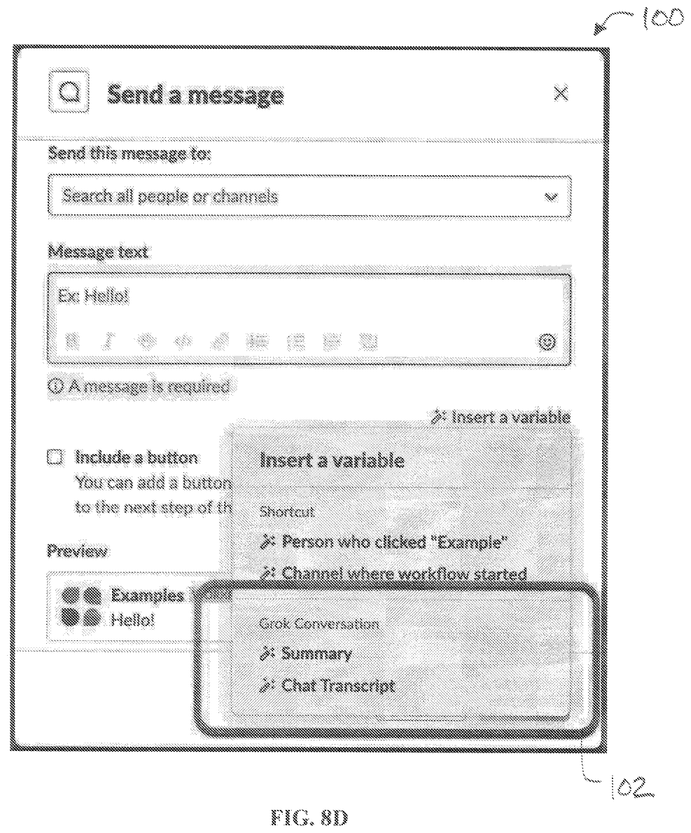

As stated in the Summary, the system and method also comprise NLP engine 92 that is preferably configured to create summaries or digests of particular conversation threads or communication channels. FIGS. 8A-8E depict embodiments for autonomously generating a conversation thread or channel summary. In embodiments, the NLP engine 92 is referred to as “Grok” or “the Grok Workflow.” The Grok Workflow may be configured to operate on any Slack Channel, Message, or Thread to produce a summary of the selection. The output can be used in other workflow steps as a variable 94. The Step Parameters, which may also dictate the summary style 93 produced by the NLP engine 92, preferably look as shown in FIG. 8A.

To illustrate some of the steps in this method, a user may select a static channel 96 as shown in FIG. 8B, or alternatively may use a variable 94 as shown in the display 98 of FIG. 8C. Optionally, a user may use a permalink to a message, hard-coded message timestamp or more commonly a variable (such as when triggered from an Emoji reaction on a message) as shown in FIG. 8D. The output can be consumed in another step as the Summary or the Chat Transcript 102, as shown in FIG. 8D. Any of these methods may be used to send a message 100 through the NLP engine 92.

Grok preferably uses the GPT-3 in conjunction with a “prompt”/“response” system. That is, the system formats a selected Slack conversation to pass on to a custom API, such as the GPT-3 API, with a prompt asking to summarize the discussion. The GPT-3 API responds with a summary, which the system passes back to the requesting user. This is reflected in FIG. 8E, which depicts a summary display 104 presented to a user once the steps above are completed.

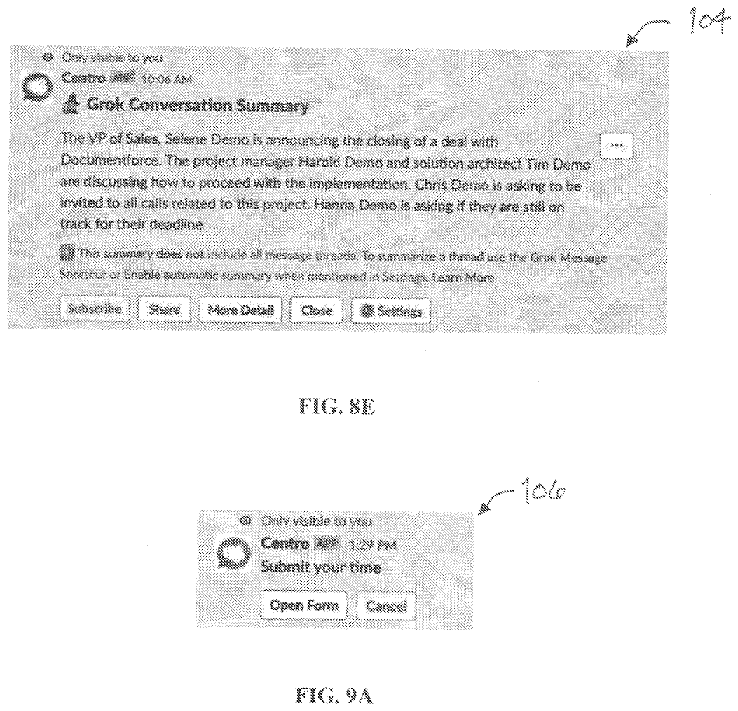

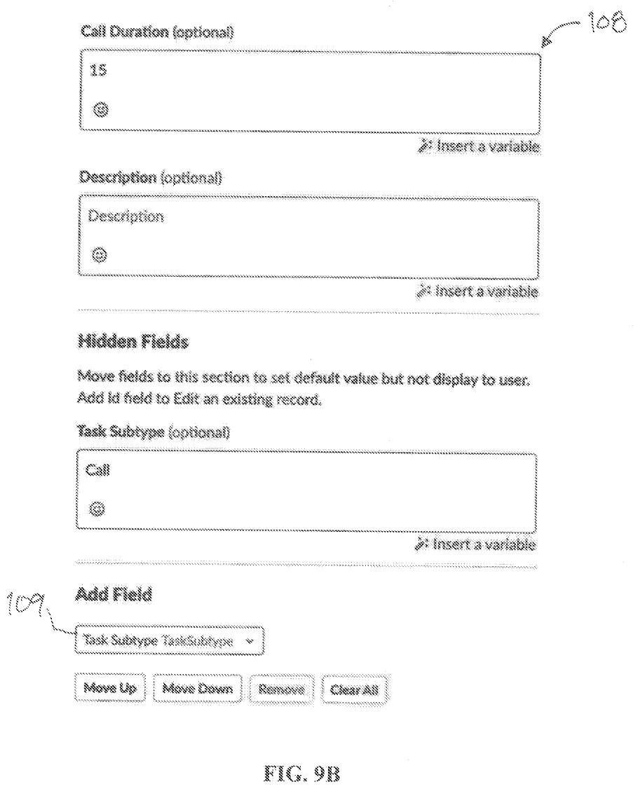

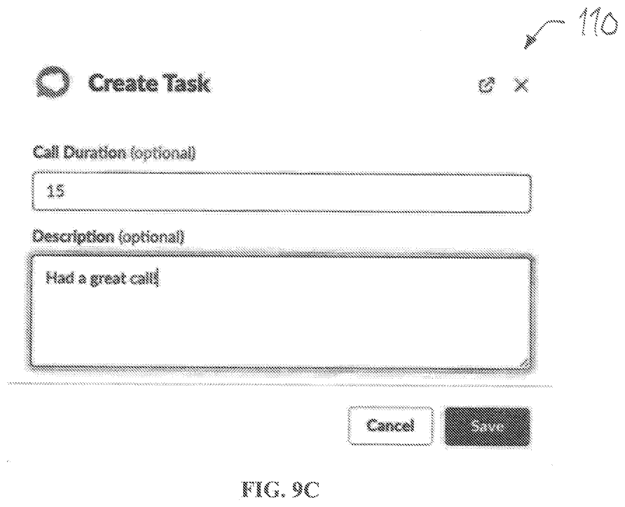

FIGS. 9A-9C depict embodiments for creating a CRM record data utilizing a custom form. In one embodiment, a user may select a Submit Salesforce Form 106 workflow step to create or edit Salesforce record data in a custom modal form. This step uses the Salesforce Connection of the user who saves the Workflow Step (as indicated when editing the Step). This allows Slack users to modify Salesforce data even if they do not have a login to Salesforce by utilizing the Workflow user's connection. This method is illustrated in FIG. 9A.

In operation, the Submit Salesforce Form step will send a user an ephemeral message only they can see allowing the user to edit and submit data in a modal form by clicking the message “Open Form” button. The fields that are displayed on this form 108 are user-configurable when editing the step. Fields may be displayed to the user, or they can be hidden from the user to set a field value to a default (i.e. for a Record Type or Status field), as shown in FIG. 9B.

A user may also add fields using the “Add Field” icon 109 in the workflow step and move fields in the order they should be displayed or move fields to the bottom to hide the field. Set default values for fields by inserting Workflow variables or specifying a constant value using the appropriate data-type formatting when creating a task 110, as shown in FIG. 9C.

Date fields should be formatted using ISO 8601 format, picklists should use appropriate API_names, lookups should specify a Salesforce Record Id of expected type, and strings and numbers should be in a format they can be parsed to expected length and type. To edit an existing Salesforce Record, specify the Record Id value as a hidden field. When the Record Id is specified, defaults will be populated using the existing Salesforce data unless overridden in the Workflow step, as further illustrated in FIG. 9C.

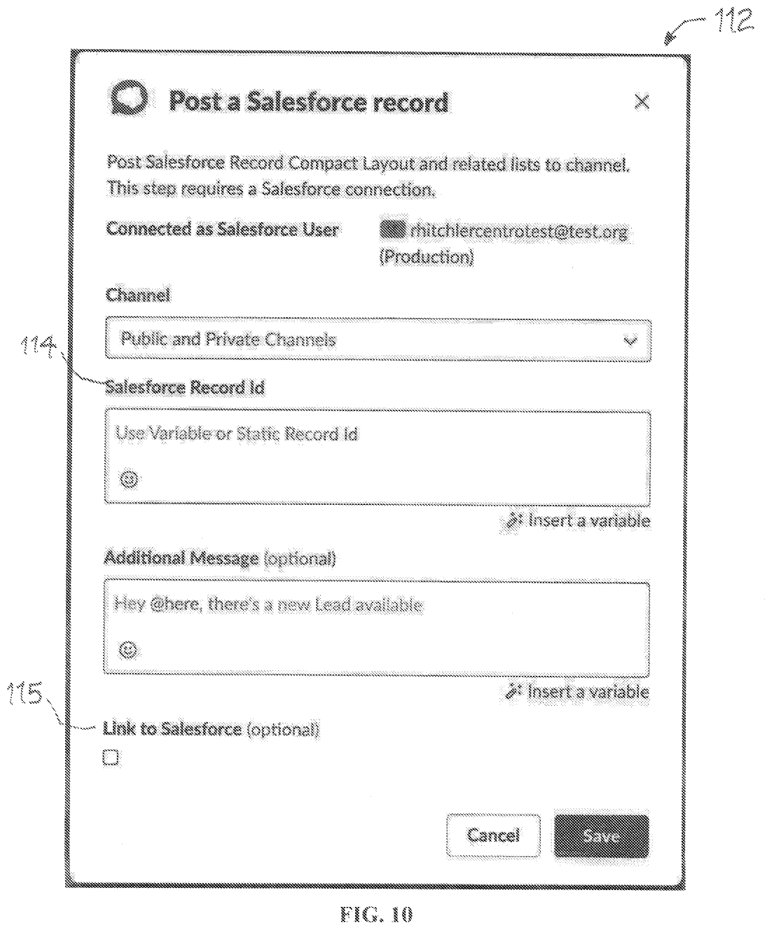

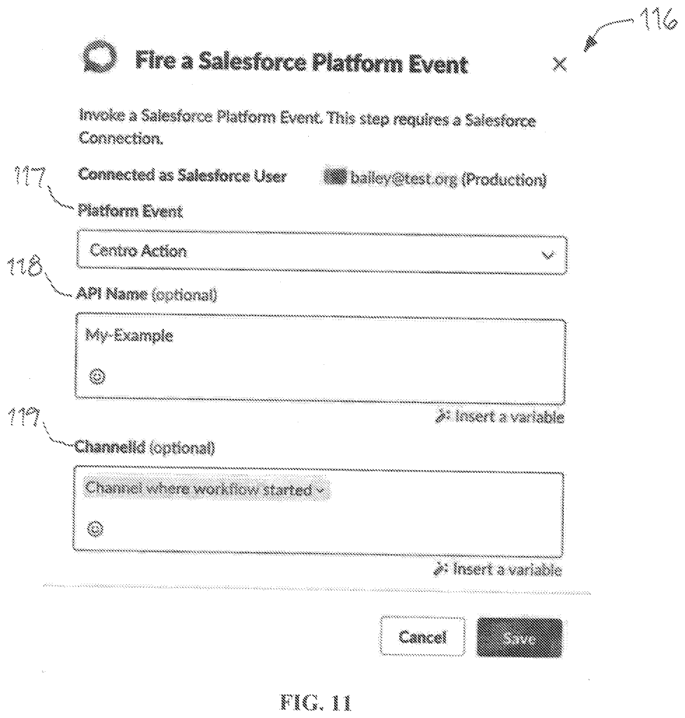

FIG. 10 depicts an embodiment for posting a CRM record 112 as a communication channel message. The Post Salesforce Record Workflow step posts a selected Salesforce record to a Slack channel as a message via the user who created the Workflow Step. The step is configured by completing the dialog shown in FIG. 10. The user preferably has two options. For instance, the user may select Connected as Salesforce User. This option is preferably not editable to the user who created the workflow Step and relies upon use the user's established Salesforce authenticated connection (via the system). Alternatively, the user may select to configure as a Channel, and either select a static channel or use a variable as described above.

The user preferably is asked to complete multiple fields to configure this workflow, as shown in FIG. 10, including the Salesforce Record ID 114. This ID is statically set using the 15-character Salesforce Record ID, or more may instead use a Record ID variable from a previous workflow step. Other fields include the Additional Message (Optional), wherein the user sets the text of a message preceding the Record Block set of fields from the Compact Layout of the record selected; Link to Salesforce 115, which appears after the message posts to the channel, show the dialog to link the Record Block to the selected Salesforce record; and, Output. The Message block will appear of the selected record, along with any Additional Messages set.

The system disclosed herein further comprises one or more methods for triggering events. Salesforce Platform Events are an event-driven messaging architecture, which enable apps to communicate inside and outside of Salesforce. Platform Events are therefore similar to Salesforce Custom Objects in that they are defined with an API Name (i.e. Event e) and with Custom Fields that can have defined name, type and value which can be utilized by event-listeners consuming the event. FIG. 11 depicts an embodiment for triggering a CRM event or event-driven message 116 inside and outside a CRM platform. When invoking a Platform Event using Slack Workflow Builder and Platform Event 117 step, the Event API Name 118 is required and Custom Field values must be specified as JSON-encoded values. JSON-encoded values comprise basic data-types such as String types, Integer and floating-point numbers, and Boolean values. Date and time values may be formatted as Strings in ISO 8601 format (i.e. YYYY-MM-DD for Dates and YYYY-MM-DDTHH:NN:SSZ for UTC time). Channel ID 119 is preferably optional, and may be requested at the time the Platform Event is generated.

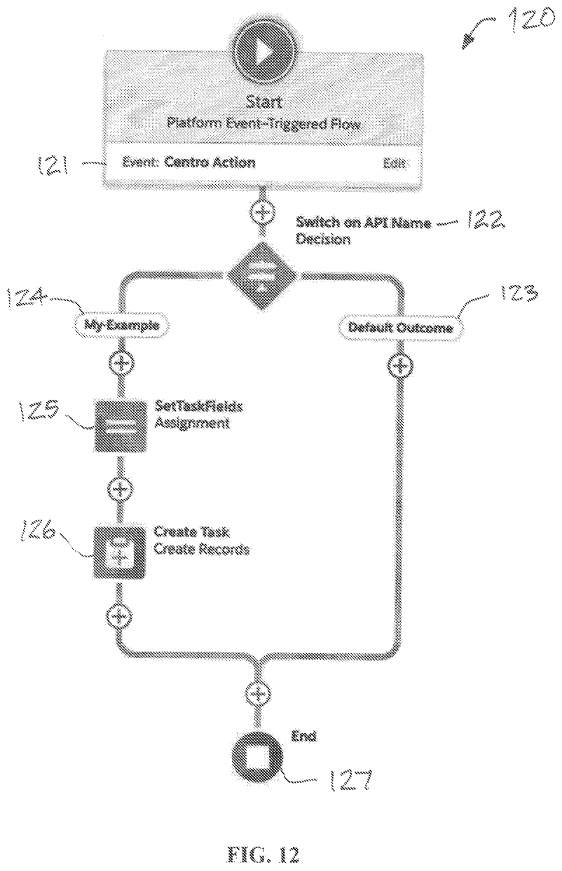

Slack Workflow variables may be used in the Platform Event Step, as shown in FIG. 11. This enables outputs from other steps in a workflow to be passed into the Platform Event and used by other integrations inside or outside of the Salesforce platform. For example, this Platform Event could trigger a Salesforce Flow process to Create a Task 120 as shown in FIG. 12, which depicts several steps 121-127 and their interrelationships in a flowchart. Other steps and conditions are further illustrated in FIG. 12.

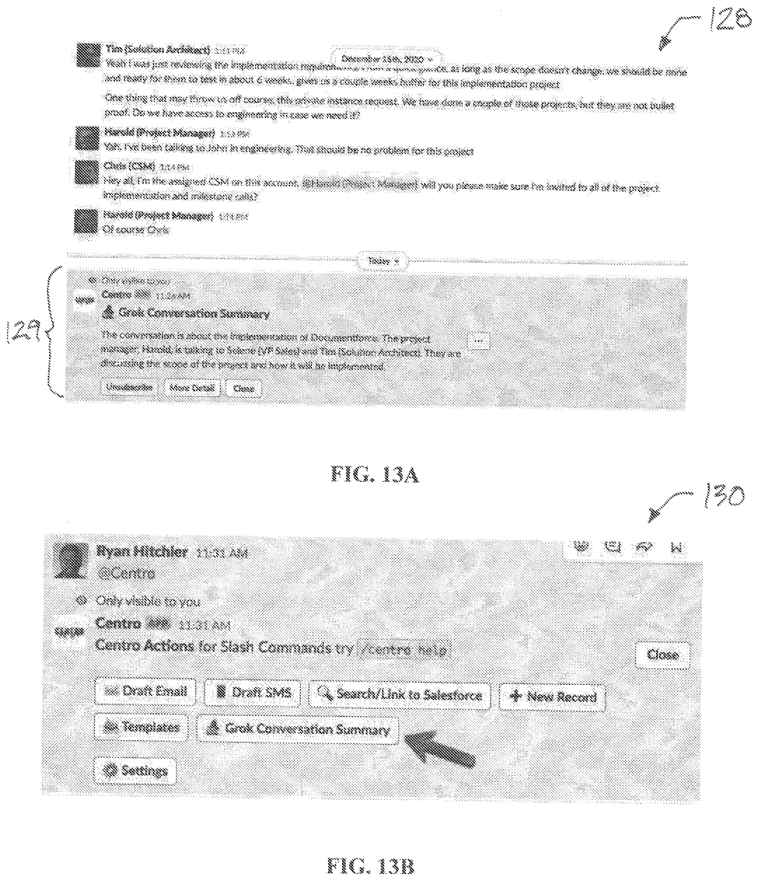

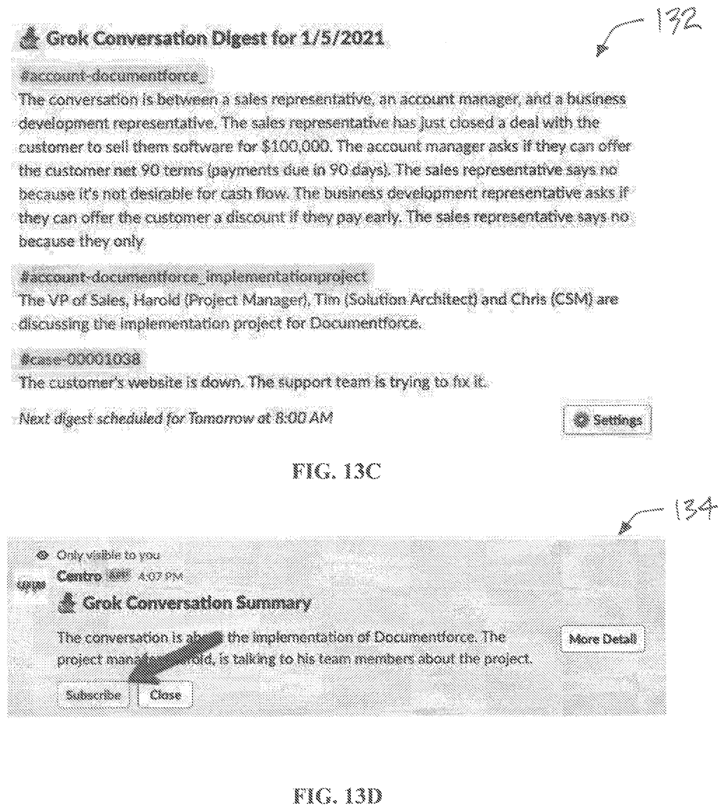

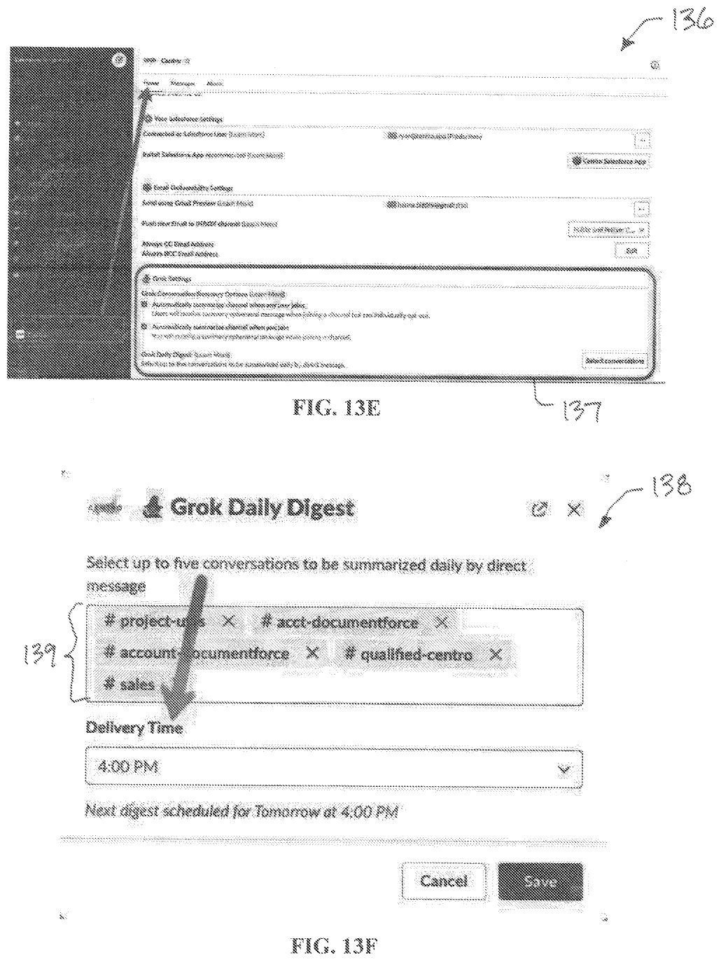

FIGS. 13A-13F depict embodiments for creating and subscribing to communication channel summaries and daily digests for any linked communication channel(s). As described above, the system preferably comprises a NLP service referred to as Grok, which utilizes an advanced AI Engine to summarize Slack Channels on-demand as well as a daily digest of subscribed channels.

The system therefore provides Single and/or On-Demand Summaries 129. Grok will typically summarize the last thirty messages in any Slack channel 128, and provide the output as shown in FIG. 13A, although a fewer or greater number of channels may be included in the summary.

The above-referenced action can be invoked by inputting “/centro summary” into any Slack Channel that Grok is aware of and clicking “Grok Conversation Summary” 130 in the actions list, as shown in FIG. 13B. Note that each on-demand message is ephemeral (only visible to the user who invoked it). By default, a concise and narrow summary concise appears. If more detail and verbose summary is desired, the user has the option of selecting a “More Detail” button/icon on the message and edit the summary accordingly.

A user may subscribe to an on-demand channel summary, which may be scheduled for a daily digest for multiple channels. An example output 132 is illustrated in FIG. 13C. To subscribe to digests, a user must first select the channels to summarize, and the time of their daily delivery. Selecting a channel involves a user choosing the communication channels they want as part of their digest in one of two ways: clicking the “Subscribe” button on any Grok on-demand summary 134, as shown in FIG. 13D, or by selecting the Go to the Centro App Home, then under the Grok Settings display 136, clicking the “Select Conversations” button 137, as shown in FIG. 13E. A user may select the frequency of the digest delivery by choosing the same “Select Conversations” button in the Grok Settings in Centro's App Home is the Delivery Time setting, as shown in the display 138 of FIG. 13F. A user may also tag conversations 139 from this display 138. In some embodiments the user is limited to five conversations, while in other instances the number may be greater.

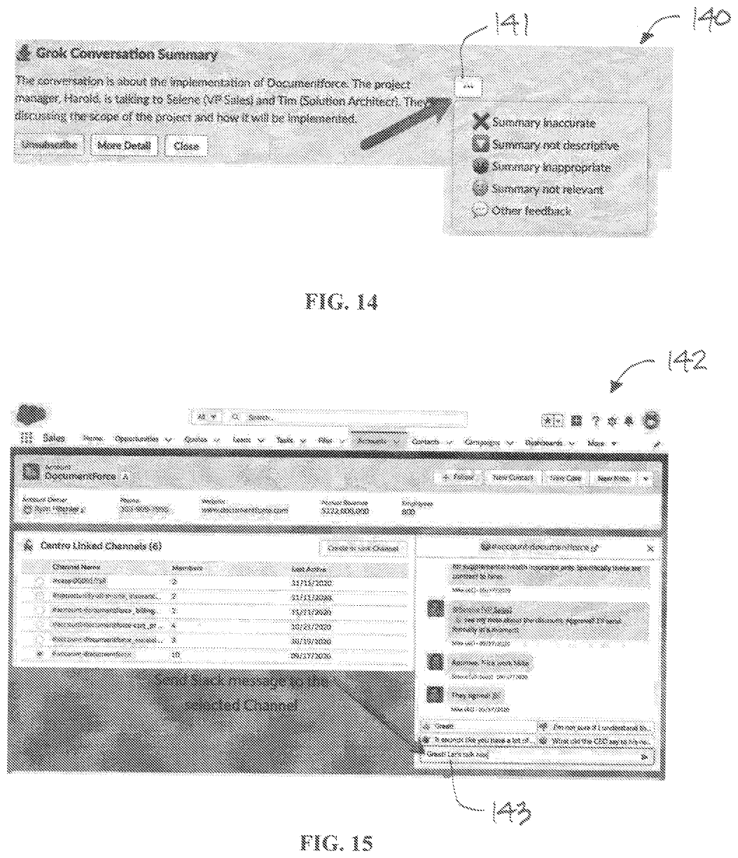

FIG. 14 depicts an embodiment 140 for providing real-time or near real-time messaging and/or feedback from a linked communication channel within a CRM platform environment. The Lightning Web Component supports sending a message to a linked Slack Channel, as shown in FIG. 14. Here, the user may complete a series of steps to configure the system, including:
1. Connect a Slack channel to a Salesforce record either from the Salesforce Lightning component (Create or Link a Channel button) or the Slack Channel Linking functionality.
2. Open the Salesforce record.
3. Select a row in the list of Linked Channels.
4. A preview window will appear. Users will see a box to send a message to that channel, as a Slack Member. Note, however, the Salesforce user must be a valid Slack member in the connected workspace.
5. If this is the first time the user has messaged a Slack channel from Salesforce, they will be prompted to connect to Slack.
6. Once they have completed the workflow, they will post a message to the selected Slack Channel from Salesforce.

The user must authenticate from Salesforce to Slack using “OAuth” workflow. This is facilitated the moment they attempt to message the channel for the first time.

A user may also link a Message or Thread from Salesforce or another CRM 143, as depicted in FIG. 15. FIG. 15 shows aspects of a system 142 for linking a thread or message between a CRM platform to a communication channel. In addition to linking public or private Slack conversations it is also possible to link single messages or entire message threads to a Salesforce record. To link a message or thread use the Centro message shortcut by clicking the message context menu. If the “Link to Salesforce” message shortcut does not appear in the menu, select “More message shortcuts” and then select “Link to Salesforce”.

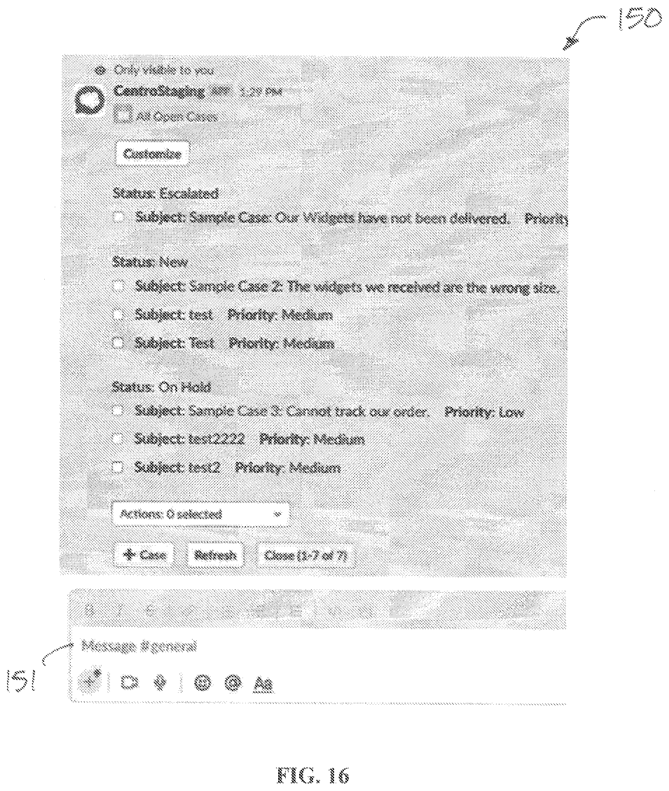

The system may also comprise a Salesforce “List View” in Slack feature, as shown in FIG. 16. This functionality includes a display or list of Salesforce record in a Slack channel that can be displayed to all users or select users ephemerally. The display can show up to four Salesforce field values, grouped by a specific field. The display preferably can show ten records at a time: if there are more records, paging options will appear. The list of record duplicates a Salesforce list view results, including filters and sort order. Actions can also be applied to one or more records within Slack, such as batch edit, batch post, and custom actions.

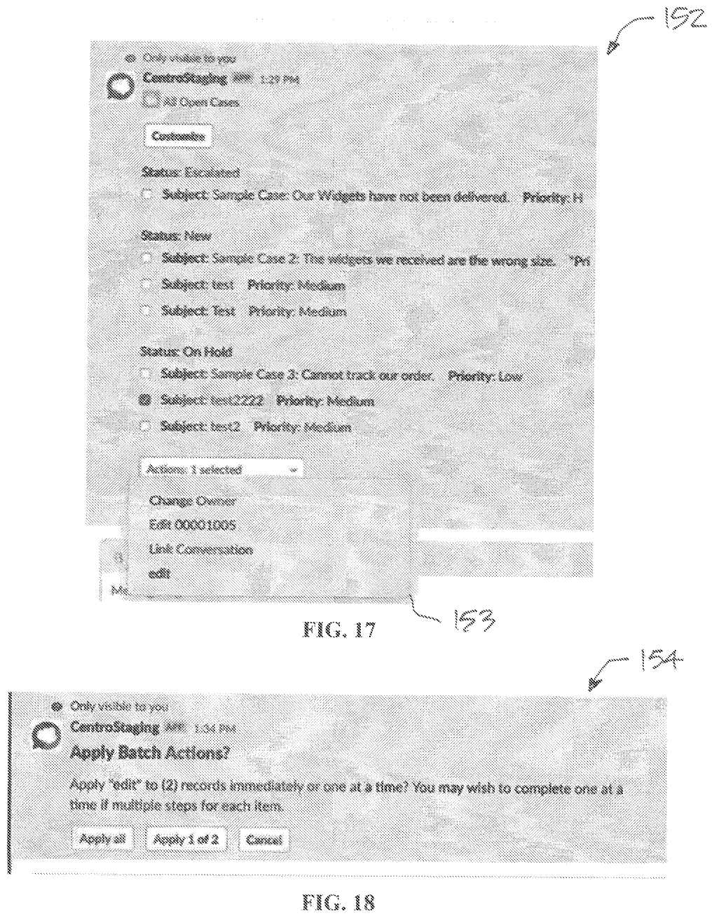

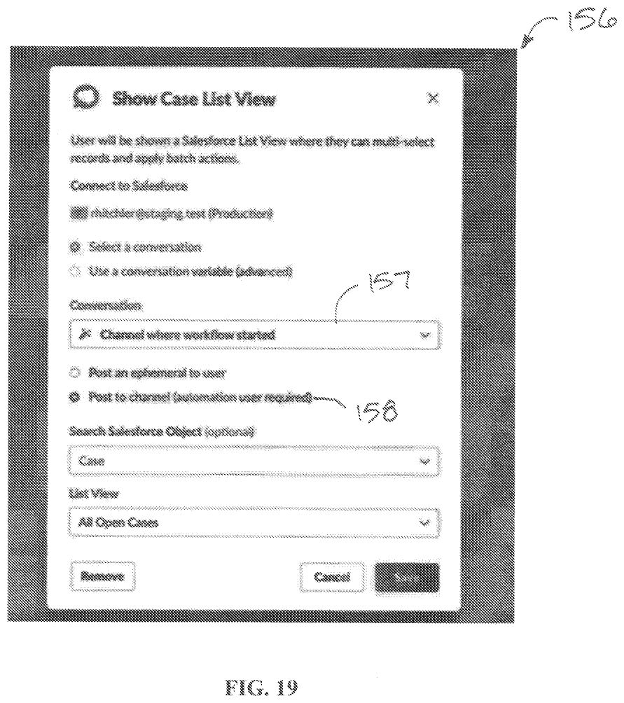

Other functionality relating to the list view feature are shown in FIGS. 17-19. FIG. 17 demonstrates one example of selecting record for Action within Slack, while FIG. 18 shows an example dialog confirming batch actions. FIG. 19 shows an example of setup for the List View step in Slack Workflow builder.

A history of linked channels 160 may be captured in a Salesforce object title “Linked Conversations”. This object holds metadata of each linked conversation, such as the Conversation Name 161, Slack Channel ID 164, the Salesforce Record ID 162, who created the channel, the Slack Message Timestamp of a linked Thread 165, and parent Account 163 (where applicable). This object can be further customized for purpose-built features. For instance, this object allows users to quickly and easily look up where conversations are located in Slack as they relate to a Salesforce object.

An additional aspect of the system is shown in FIG. 21. This system 170 may provide for live messaging 172, which enables the same concept of live chat offered for Salesforce Experience Cloud sites/pages, which are external websites 173 for customers to engage with select CRM data. In this embodiment, multiple Cases 171 may be selected. The Lightning Web Component described above in relation to FIG. 14 can therefore be configured for two purposes: Creating a static Slack channel where users logging in will always see the same chat channel, and agents on the other side are able to work in Slack or Salesforce directly to support that user; or creating a dynamically assigned Slack channel based on individual Salesforce records; that is, if you want to chat with a team about a support case, you may do so with the Lightning Web Component.

Users from the Salesforce Experience cloud may engage on the chat channel in one of two ways: Authenticated to Slack—that is, they have a Slack user account and that user profile will be adopted by the Lightning Web component; or No Slack authentication, which preferably utilizes Salesforce Experience Cloud user profile. In the case where the User needs support in Slack, but does not have a Slack license, the system will post a message leveraging the Experience Cloud elements such as the User Name and Avatar.

In the foregoing description, for the purposes of illustration, systems and methods were described in a particular order. It should be appreciated that in alternate embodiments, the methods may be performed in a different order than that described. It should also be appreciated that the methods described above may be performed by hardware components or may be embodied in sequences of executable instructions on machine-readable media, and which cause a machine, such as a general-purpose or special-purpose processor or logic circuits programmed with the instructions to perform the methods. These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process, which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the Figures. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the invention have been described in detail herein, it is to be understood that the inventive concepts may be otherwise variously embodied and employed, and that the appended claims are intended to be construed to include such variations, except as limited by the prior art.

1. A system for integrating communications channels and a Customer Relations Management (CRM) platform, such as Salesforce, comprising:
Computational equipment specifically configured to link records in a CRM platform with at least one communication channel;
the at least one communication channel coupled to the CRM by the linked records;
at least one database configured to store data from the linked records;
a Natural Language Processing engine coupled to the database and capable of reading and compiling linked records based on (1) a specific one of the at least one communication channel, (2) natural language appearing in threads contained within the at least one communication channel, and (3) user-inputted identifiers that identify a specific type of thread;
wherein the system is configured to generate at least one summary of communications made over the at least one communication channel, and wherein the system is further configured to generate at least one digest of one or more of the at least one communication channels.
